(19) United States
(12) Patent Application Publication
(10) Pub. No.: US 2025/0021493 A1
(43) Pub. Date: Jan. 16, 2025

(54) METHOD FOR OPERATING A MEMORY MODULE, MEMORY CONTROLLER, AND MEMS COMPONENT

(71) Applicant: Robert Bosch GmbH, Stuttgart (DE)

(72) Inventor: Timo Giesselmann, Stuttgart (DE)

(21) Appl. No.: 18/765,685

(22) Filed: Jul. 8, 2024

(30) Foreign Application Priority Data
Jul. 12, 2023 (DE) 10 2023 206 623.8

(51) Int. Cl. G06F 12/14

(52) U.S. Cl. CPC G06F 12/1433; G06F 12/1458

(57) ABSTRACT

A method for operating a memory module. The method includes: providing a memory module in a first step, the memory module including a memory area with a plurality of memory cells having data; providing at least one address boundary register with at least one address boundary, the value of which can be changed at least in one direction in a second step; wherein the provision of the at least one address boundary register in the second step includes that the address boundary can be set to a new value and it can be checked whether the new value has been changed in the permissible direction; and when there is an access, in particular a write access and/or read access, to the data in the memory cell of the memory module, checking whether the access is permitted, and, if the access is permitted, executing the access in a third step.

### CROSS REFERENCE

The present application claims the benefit under 35 U.S.C. § 119 of German Patent Application No. DE 10 2023 206 623.8 filed on Jul. 12, 2023, which is expressly incorporated herein by reference in its entirety.

### FIELD

The present invention relates to a method for operating a memory module. Furthermore, the present invention relates to a memory controller and a MEMS component, comprising a memory controller with a memory module.

### BACKGROUND INFORMATION

An object of the present invention is to provide an improved method for operating a memory module, as well as an improved memory controller and an improved MEMS component.

This object may be achieved by features of the present invention. Advantageous example embodiments of the present invention are disclosed herein.

### SUMMARY

According to an example embodiment of the present invention, a method for operating a memory module is proposed, comprising the following steps:
providing a memory module in a first step, wherein the memory module comprises a memory area with a plurality of memory cells having data,
providing at least one address boundary register with at least one address boundary, the value of which can be changed at least in one direction, in a second step,
wherein the provision of the at least one address boundary register in the second step comprises that the address boundary can be set to a new value and it can be checked whether the new value has been changed in the permissible direction, and when there is an access, in particular a write access and/or read access, of the data in the memory cell of the memory module, checking whether the access is permitted and, if the access is permitted, executing the access in a third step.

The term “data” can be understood as a synonym for “data objects.”

For access to the memory module, an access range for possible access addresses is defined. Outside this access range, read and/or write access is not possible. For example, access may not be permitted if the access address is not within the relevant access range (this may vary depending on the implementation of the address boundary register).

In particular, if access to the data of the memory cell is not permitted in the third step, it is possible that access to the data of the memory cell is not carried out and an error message is generated. This can advantageously improve security and protect important data from unauthorized access. The error message can be generated, for example, by the processing unit or its software module.

Microelectromechanical components (MEMS components, MEMS: microelectromechanical system) which are designed as MEMS sensors are used in a wide variety of applications, for example in smartphones, game controllers, smart watches, drones, headphones or other mobile devices. The list is not intended to be exhaustive. MEMS sensors include evaluation circuits (e.g. ASIC elements (ASIC: application-specific integrated circuit), which can include microprocessor-based systems with memory controls. The microprocessor-based systems with memory controllers can include processing units that are designed as CPUs and, with memory modules/memories and peripherals, can be connected to one another via a bus system. The memory modules can be designed as different types, e.g., as non-volatile memories (NVM) or as volatile memories, wherein the access control or the method for operating the memory module can preferably be used for memory modules that are designed as NVM memories. The memory modules are used, for example, in training as NVM memory to store:
Program code that runs on the microprocessor-based system (firmware)
Calibration data for ASIC or MEMS-specific functions (e.g. VREG (voltage regulator) or POR adjustment (power-on-reset adjustment), oscillator trimming, offset and gain adjustment for sensors)
Part-specific manufacturing information, e.g. unique ID, wafer ID and die coordinates, product variants, feature bits, e. g. for blocking specific functions (e.g. switching off memory blocks)
Security key, e.g. for
   Authentication of firmware images
   Authentication of access rights, e.g. for reading/writing comparison data
   Decryption of firmware images
   Encryption of sensor data
   Authentication of sensor data

The terms firmware and software can be understood here as synonyms.

Access rights to the memory module must be managed because different data or contents may not always be accessible by the software. For example:
Trim data may not be changed after adjustment.
Wafer data may not be read without authorization.
Security keys may not be changed or read.

Up to now, this access control for a memory module has been implemented for example via lock bits in hardware. Using lock bits, it is possible to control the entire memory module or fixed sections of the memory module. The software bits (lock bits) can be written once after a start process (reset) to lock/allow access, i.e., write access and/or read access. It is not possible to change or unlock the lock bits again until the next start process (reset). The disadvantage of the conventional method and the conventional memory controller is the fact that access is only enabled/prevented to the entire memory module, or a fixed sector size for the individual access ranges would have to be specified in hardware. The software or firmware has only limited decision-making power regarding when and how access is permitted/prevented.

An example method according to the present invention advantageously allows flexible access control to the memory module, which is preferably designed as a non-volatile memory, that does not require that specifications regarding the size and access restrictions for individual memory cells of a memory area have to be made in the hardware design. Instead, the definition of access can be flexibly defined in the firmware so that it can be handled flexibly and can also be changed by updates to the firmware.

In this way, sensitive data can be protected as best as possible, because an access range for possible access addresses is defined for access to the memory module. Outside this access range, read and/or write access is not possible. The access range of the address boundary register is defined at least based on an access address which, in a first embodiment, is above the value of the address boundary of the address boundary register (in the case of implementation with ascending address boundaries) or corresponds to the corresponding address boundary. In a second embodiment, the access range is defined at least based on an access address that is below the value of the address boundary (in the case of implementation with descending address boundaries) of the address boundary register or corresponds to the corresponding address boundary. A combination of ascending and descending address boundaries using a plurality of address boundary registers is also possible. In this case, access would only be possible if the access address is above one address boundary register and below the other address boundary register.

The flexibility of the method according to the present invention is also demonstrated by the fact that the at least one address boundary register can be set only for write accesses and/or only for read accesses and/or in the case of a plurality of independent address boundary registers, one can be set for write accesses and one for read accesses.

In a further example embodiment of the present invention, the third step can be carried out without the second step having been carried out beforehand. For example, a scenario is possible in which the address boundary is set to zero after a system reset, which means that all accesses are executed. Changing the address boundary and actually accessing the data in the memory cell of the memory module are independent events that can occur in any number and sequence.

In a further example embodiment of the present invention, the third step is repeated a plurality of times. For example, it is possible that the third step occurs a plurality of times without the second step occurring. Changing the address boundary and actually accessing the data in the memory cell of the memory module are independent events that can occur in any number and sequence.

In a further example embodiment of the present invention, the second step is repeatedly carried out a plurality of times without the third step having been carried out. Changing the address boundary and actually accessing the data in the memory cell of the memory module are independent events that can occur in any number and sequence.

In a further example embodiment of the present invention, the second and third steps are repeated a plurality of times. Changing the address boundary and actually accessing the data in the memory cell of the memory module are independent events that can occur in any number and sequence.

Furthermore, according to an example embodiment of the present invention, a memory controller is provided, comprising the following components:
a processing unit which is operatively connected via a bus system to a memory module which is designed in particular as a non-volatile memory,
wherein the memory module comprises a memory area with a plurality of memory cells having data,
wherein the memory controller comprises an address logic module operatively connected to the processing unit and the memory module via the bus system,
wherein the address logic module is designed to provide at least one address boundary register with at least one address boundary,
wherein the processing unit comprises a software module which is designed to change the value of at least one address boundary in at least one direction,
wherein the address logic module is designed to set the address boundary to a new value and to check whether the new value has been changed in the permissible direction,
wherein the address logic module comprises at least one logic comparator element,
wherein the logic comparator element is designed for access, in particular write access and/or read access, to data of the memory cells, to check whether the access is permissible, and if the access is permissible to execute the access.

The memory controller according to the present invention comprising a memory module can be easily realized to implement the method for operating a memory module. For example, possible access with the address logic or an address logic module used can be implemented with only a few components, e.g. one logic comparator element each for a write access or read access. A logic comparator element can also be understood as a comparator.

Advantageously, no assumptions have to be made about the size of the possible access range when designing the memory module and the hardware. The access range can be designed as described above and subsequently be flexibly defined in the software module, i.e. in the software, and can be variably adapted during the life cycle of the product by firmware updates. The term “software module” can be understood as a synonym for “software” or “firmware.”

In a further example embodiment of the present invention, the at least one address boundary register is designed as a digital flip-flop component in hardware. The digital flip-flop component is designed to check whether the new value of the address boundary has been changed in the permissible direction. Advantageously, no pure software implementation is required. However, it is understood that the setting of the flip-flop component can be done by means of program code (e.g. C++ or similar).

In another example embodiment of the present invention, access to sensor calibration data, security keys, and/or firmware objects is controlled. The method is therefore particularly suitable for use in conjunction with MEMS sensors.

In a further example embodiment of the present invention, the software module, which is executed in particular on the microprocessor system in the form of software, is designed to set the address boundary register to higher values step by step during the start process and thus to close access to data objects as soon as access to the data objects has to be protected. This makes it possible to specifically protect data or data objects from unauthorized access.

In a further example embodiment of the present invention, the address boundary register can be implemented in ascending order in the address boundaries. The software module of the processing unit is designed to set at least one address boundary of the address boundary register in the direction of ascending value. The software module of the processing unit is further designed to transmit the set value of the address boundary to the address logic module. The address logic module is designed to set the address boundary to the smallest possible value of the memory module at system start and to check whether a new set value of the address boundary is greater than a previous value and, if so, to adopt the set value of the address boundary. The address logic module is designed to grant access to the processing unit if the access address has a value that is at least equal to the value of the address boundary and/or is above the value of the address boundary.

This advantageously enables flexible access control for the memory module of the proposed memory controller by implementation in firmware. Different data or data elements can be stored in ascending order in the individual memory cells of the memory module. Immediately after starting the firmware, access to all memory cells (data elements) is possible. During the boot process, the write or read access to the memory cells of the memory area of the memory module can be successively restricted by setting at least one changeable address boundary to higher or larger values. Since the address boundary register can no longer be reset to smaller values later on, less privileged parts of the firmware can be effectively prevented from accessing data containing these memory cells.

For the ascending implementation of the address boundaries, it is necessary that the start address of the address boundary register points to the lowest address of the memory module after the start process (reset). Alternatively, the start address can be set to zero. Here the start address can correspond to the changeable address boundary. A change by register write access to the address boundary register is then only successful if the newly written address boundary is larger than the current one (changeable address boundary).

In a further example embodiment of the present invention, the address boundary register can be implemented in descending order in the address boundaries. The software module of the processing unit is designed to set at least one address boundary of the address boundary register in the direction of descending value. The software module of the processing unit is further designed to transmit the set value to the address logic module.

The address logic module is designed to set the address boundary to the largest possible value of the memory module at system start and to check whether a new set value of the address boundary is less than a previous value and, if so, to adopt the set value of the address boundary. The address logic module is designed to grant access to the processing unit if the access address has a value that is at least equal to the value of the address boundary and/or is below the value of the address boundary.

This implementation is advantageously possible provided that the start address of the address boundary register points to the highest or maximum address after the start process (reset). Here the start address can correspond to the changeable address boundary. A change by register write access to the address boundary register is then only successful if the newly written address boundary is smaller than the current one (changeable address boundary).

In a further example embodiment of the present invention, at least one first address boundary register and one second address boundary register can be implemented, which can be formed independently of one another. This advantageously allows independent access ranges, wherein the access ranges can be implemented, for example, as a combination of the above-mentioned ascending and descending implementation of the address boundaries for the independent address boundary registers. It is possible here that firmware artifacts are stored in the first address boundary register (locked in the lower address range for access addresses) and secured by ascending implementation of the address boundaries of the first address boundary register, while security keys and trim data are stored in the second address boundary register (locked in the upper address range for access addresses) and secured by descending implementation of the address boundaries of the second address boundary register.

In a further example embodiment of the present invention, the address logic module comprises a switch element. The switch element is designed to switch from at least one first address boundary register to a second address boundary register and/or the switch element is designed to switch from at least one second address boundary register to a first address boundary register. The first address boundary register and the second address boundary register can be formed independently of each other.

Advantageously, the address boundary registers, which are formed independently of one another, can be designed depending on the type of write or read access and, for example, can map the different rights of the processing unit. The processing unit can be designed as a processor or CPU. The different rights of the processing unit are, for example, kernel mode (operating system, protected mode) and user mode (software, unprotected mode). Kernel and user mode (or protected and unprotected mode) can thus be formed as independent address boundary registers with the above-mentioned features for the changeable address boundaries.

In a further example embodiment of the present invention, the address boundary register with the changeable address boundary has a maximum size during a start process, in particular a software power-up process and/or a hardware reset process, which is designed to be reduced after the start process.

Advantageously, the address boundary register can only be reduced in size after the start process and cannot be enlarged, in order to be able to easily and reliably save data or data elements that require protection in the lower or upper part of the address boundary register. This is because access to these data or data elements is not possible outside the access range (as defined above, for example, depending on the implementation of the address boundary register(s)). “Start process” and “start procedure” can be understood here as synonyms.

Furthermore, according to an example embodiment of the present invention, a MEMS component is provided, comprising:
a MEMS element which is designed as a sensor element, in particular an inertial sensor element, and
an evaluation circuit comprising a microprocessor system with a memory controller which has the above-mentioned features and is designed to carry out the above-mentioned method for operating the memory module.

Advantageously, the MEMS component can be flexible and, depending on the requirements, can also form a micromechanical sensor system comprising a plurality of sensor elements, which can include the above-mentioned memory controller. The evaluation circuit can be implemented, for example, by an ASIC element that includes the microprocessor system and the memory controller. This advantageously saves installation space. It is also possible that the MEMS component forms a microelectromechanical system.

The implementation of the memory controller, i.e., the memory access controller, has the advantage that it can be realized with very little hardware outlay and logic area on the sensor ASIC and still achieves a strong protective effect for the protected memory areas. This is particularly advantageous for implementation in MEMS sensors, since the ASICs used there are limited in area due to their size, and therefore more complex memory access controllers are disadvantageous due to their logic area.

The above-described properties, features, and advantages of the present invention and the way in which they are achieved become clearer and more readily comprehensible in connection with the following description of exemplary embodiments, which are explained in more detail in connection with the schematic figures.

### BRIEF DESCRIPTION OF THE DRAWINGS

FIG. 1 is a schematic representation of a method for operating a memory module, according to an example embodiment of the present invention.

FIG. 2A is a schematic representation of an implementation of an address boundary register with ascending address boundaries of the method in FIG. 1, according to an example embodiment of the present invention.

FIG. 2B is a schematic representation of an implementation of an address boundary register with descending address boundaries of the method in FIG. 1, according to an example embodiment of the present invention.

FIG. 2C is a schematic representation of an implementation of two independent address boundary registers in FIG. 1, according to an example embodiment of the present invention.

FIG. 3A is a schematic representation of the implementation of the address boundary register in FIG. 2A using a flip-flop component, according to an example embodiment of the present invention.

FIG. 3B is a schematic representation of the implementation of the address boundary register in FIG. 2B using a flip-flop component, according to an example embodiment of the present invention.

FIG. 4A is a schematic representation of a memory controller with the implementation of the address boundary register with ascending address boundaries according to FIGS. 2A and 3A, according to an example embodiment of the present invention.

FIG. 4B is a schematic representation of a memory controller with the implementation of the address boundary register with descending address boundaries according to FIGS. 2B and 3B, according to an example embodiment of the present invention.

FIG. 4C is a schematic representation of a memory controller with the implementation of two independent address boundary registers in FIG. 2C, according to an example embodiment of the present invention.

FIG. 4D is a schematic representation of a memory controller with the implementation of two independent address boundary registers according to FIGS. 2C and 3C, according to an example embodiment of the present invention.

FIG. 5 is a schematic representation of a MEMS component.

### DETAILED DESCRIPTION OF EXAMPLE EMBODIMENTS

The figures are merely schematic and are not true to scale. In this sense, components and elements shown in the figures may be shown exaggeratedly large or reduced in size for better understanding. It is also pointed out that the reference signs in the figures have been selected to be unchanged or similar for elements and/or components that are designed identically or similarly.

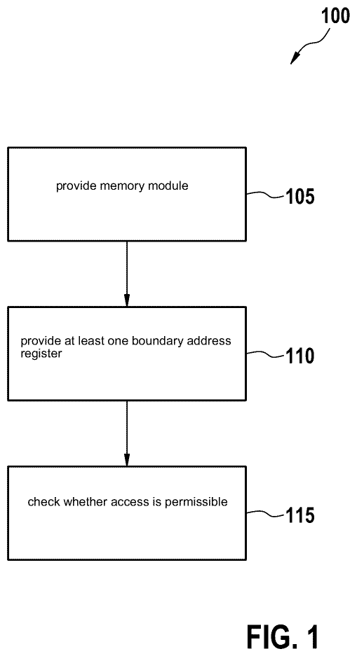

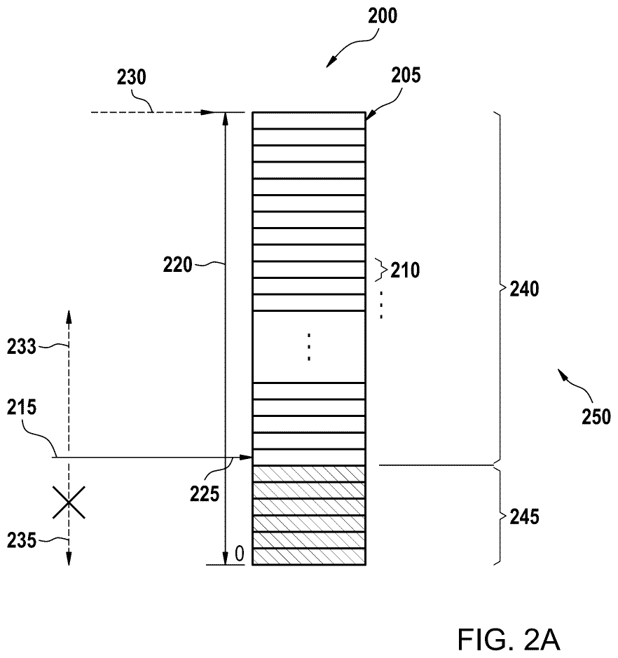

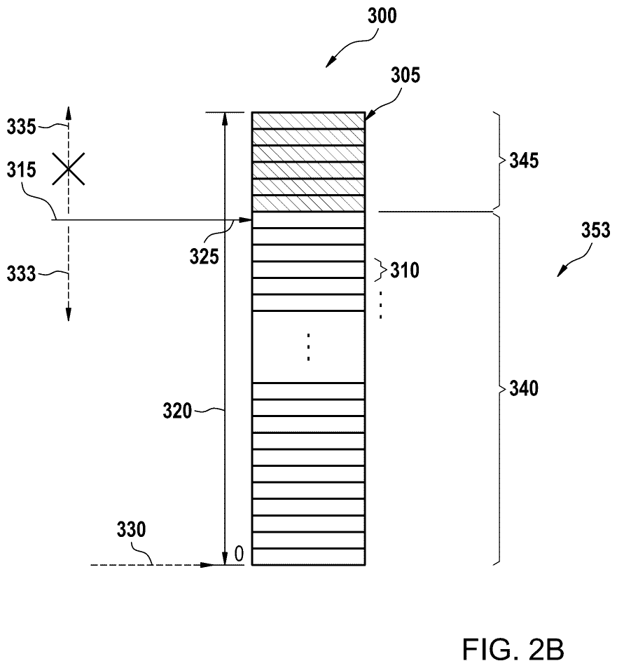

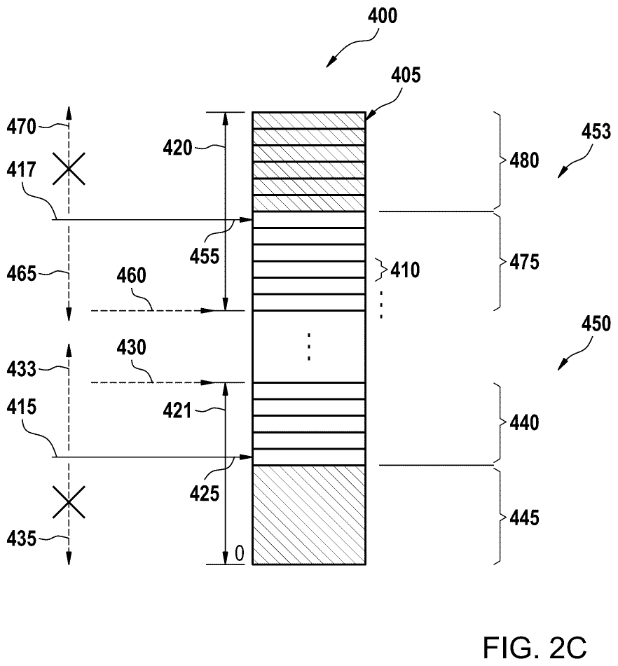

FIG. 1 is a schematic representation of a method 100 for operating a memory module 200, 300, 400. Possible implementations of the memory module 200, 300, 400 are shown in the following FIGS. 2A to 2C.

The method 100 in FIG. 1 comprises, in a first step 105, providing the memory module 200, 300, 400, wherein the memory module 200, 300, 400 comprises a memory area 205, 305, 405 with a plurality of memory cells 210, 310, 410 having data (not shown in FIG. 1). A second step 110 of the method 100 comprises providing at least one address boundary register 215, 315, 415, 417 with at least one address boundary 225, 325, 425, 455, which can be changed in value at least in one direction. The provision of the at least one address boundary register in the second step 110 includes that the address boundary 225, 325, 425, 455 can be set to a new value and it can be checked whether the new value has been changed in the permissible direction.

Advantageously, in the hardware design it is not necessary to make any specifications regarding the size and access restrictions for memory modules 200, 300, 400 with memory areas 205, 305, 405. Using the proposed address boundary register 215, 315, 415, 417 with at least one address boundary 225, 325, 425, 455 of which the value can be changed in one direction, the determination of access, in particular write access and/or read access, to the data of the memory cells can be made flexibly in the firmware, i.e. in the software. This has the advantage that access can be handled flexibly and can also be changed, for example, by updating the firmware.

In a third step 115 of the method 100, when there is access, in particular write access and/or read access, to the data of the memory cell 210, 310, 410 of the memory module 200, 300, 400 it is checked whether the access is permissible, and if the access is permissible it is carried out.

For access to the memory module, an access range is defined for possible access addresses 240, 340, 440, 475. Outside this access range, read access and/or write access is not possible. Access may therefore not be permitted, for example, if the access address 245, 345, 445, 480 is not within the relevant access range (this may vary depending on the implementation of the address boundary register).

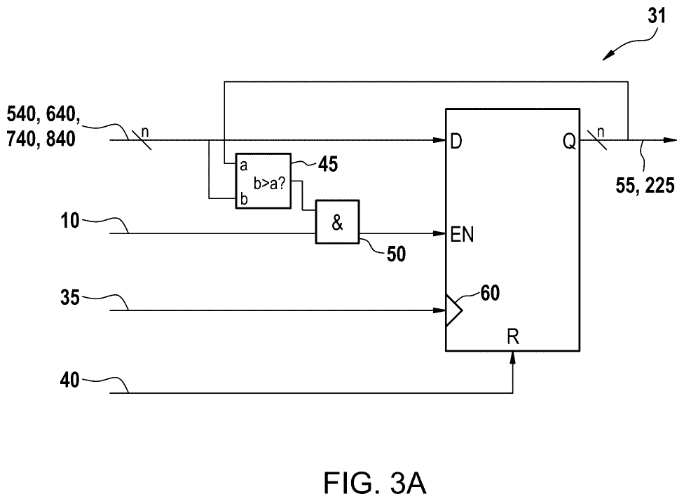

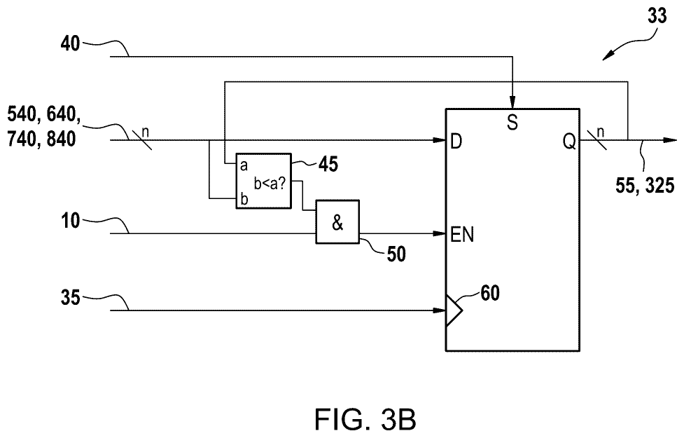

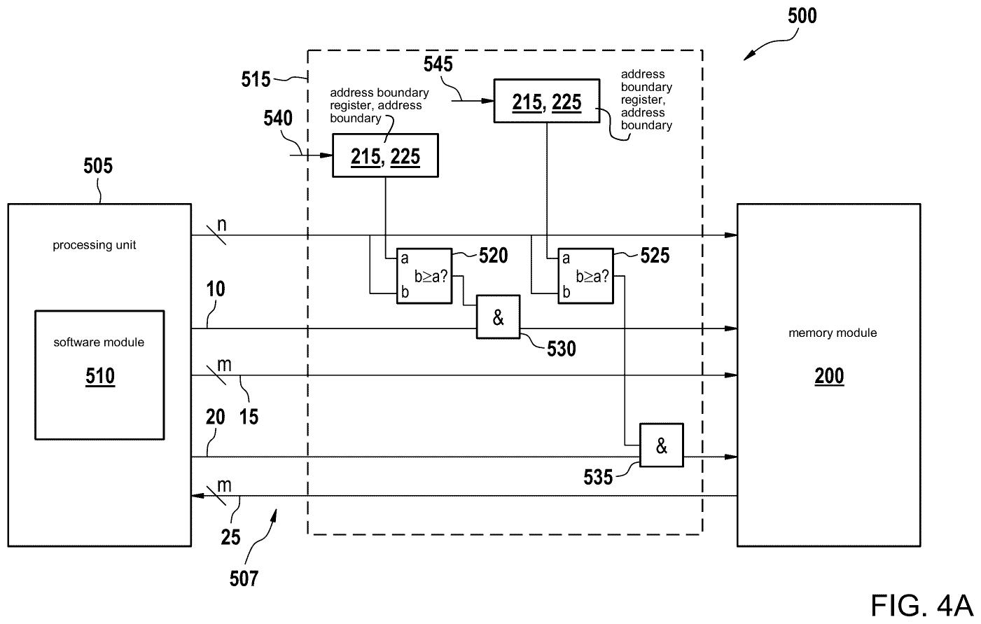

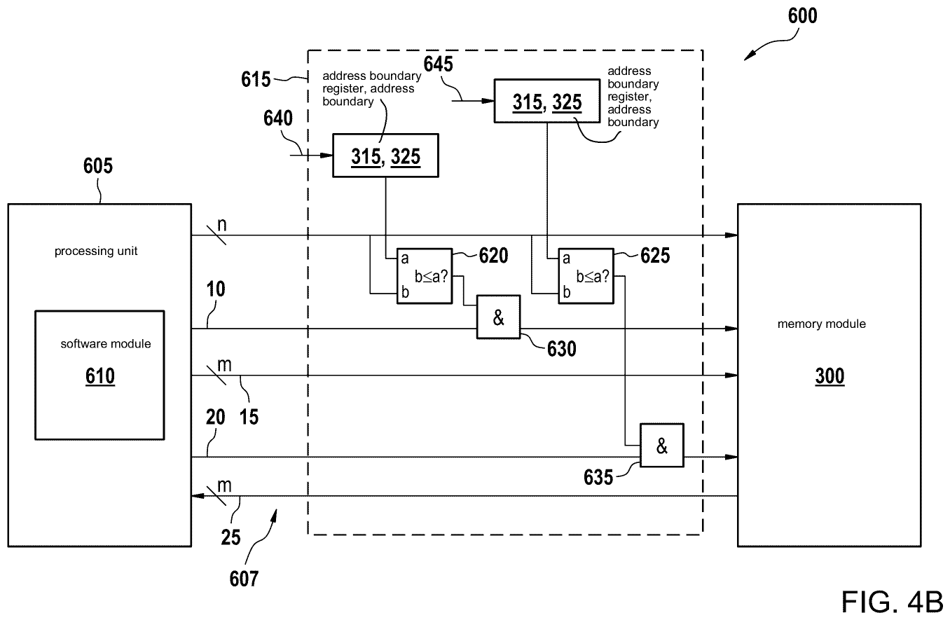

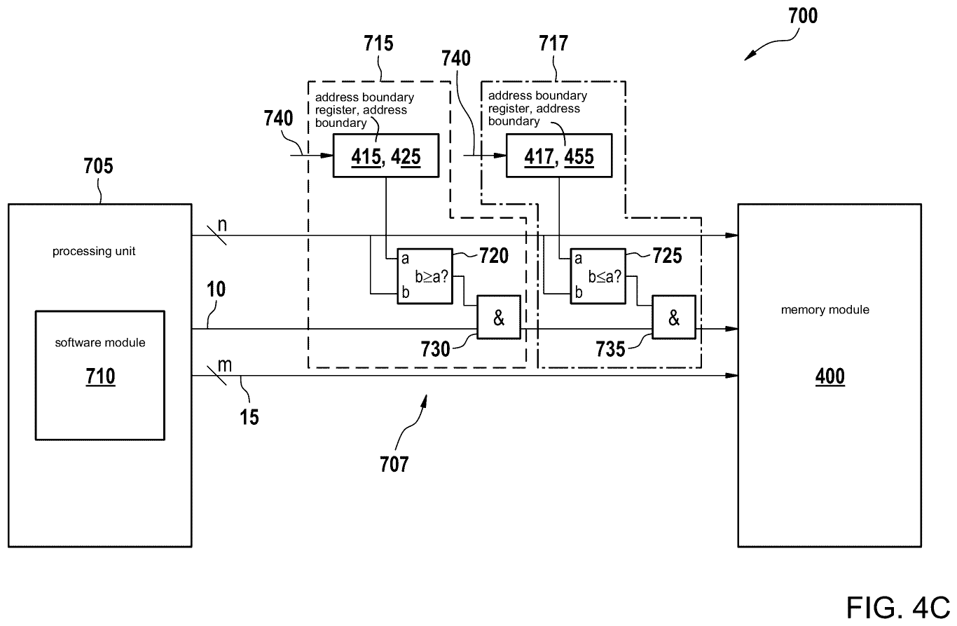

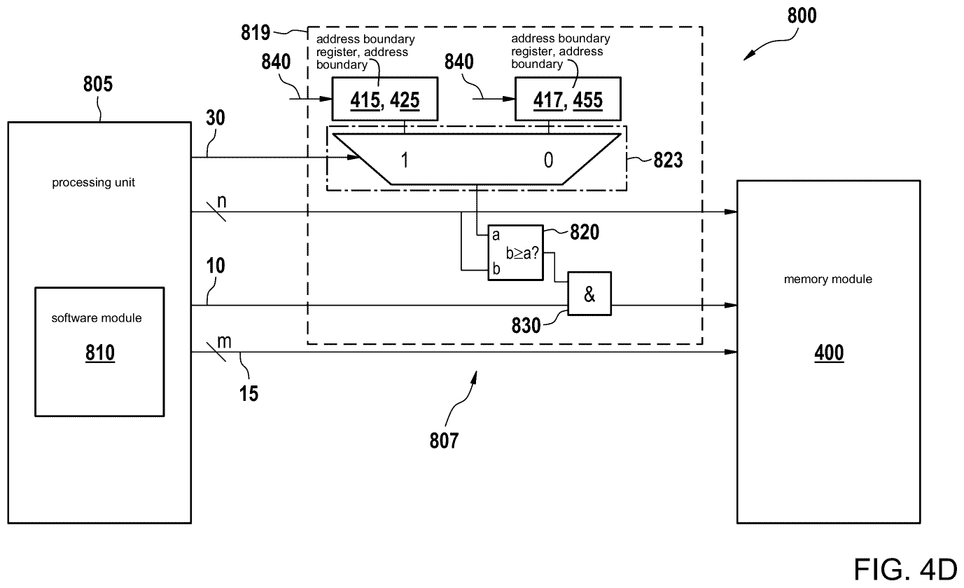

In the following, FIGS. 2A, 3A, and 4A are described together. FIG. 2A is a schematic representation of an implementation of an address boundary register 215 with ascending address boundaries 250 of the method 100 in FIG. 1 and FIG. 3A is a schematic representation of the implementation of the address boundary register 215 in FIG. 2A by means of flip-flop component 31, which can be set for example using program code (C++ or similar). FIG. 4A is a schematic representation of a memory controller 500 with the implementation of the address boundary register 215 with address boundaries 250 set in the direction f ascending value according to FIGS. 2A and 3A.

The address boundary register 215 in FIG. 2A is implemented in ascending order 250 of the address boundaries. During a system start, in particular a software power-up process and/or a hardware reset process, the address boundary register 215 has a minimum value of zero, which can be increased after the system start. A range 220 of the address boundary register 215 for possible address boundaries is also shown in FIG. 2A. This range 220 is at its largest at system start and can then be reduced by the address boundary register 215 implemented in ascending order 250 of the address boundaries. In the implementation of the address boundary register 215 in FIG. 2A by means of digital flip-flop component 31 in FIG. 3A, the start process (here designed as a reset 40) is shown via the reset input R. This can include the value zero. It goes without saying that in an alternative embodiment, the smallest value would also be possible instead of zero. The digital flip-flop component 31 (flip-flop gate) is a component controlled by a clock signal 35 (clock), which is shown in FIG. 3A via the clock circuit symbol 60 (or the dynamic input) of the flip-flop component 31.

The data can be stored in the multiple memory cells 210, for example in ascending order (in an alternative embodiment, descending storage is also possible, for example according to FIG. 2B, where the data can form the calibration data, security keys, trim data, etc., as explained above). Immediately after the start process, or after starting the firmware, i.e. the software, access to all memory cells is possible, wherein it is understood that the memory cell 210 is only shown as an example for explanation with the reference number 210, and this is not to be understood as restricting it to a single memory cell 210. During the boot process, the write and/or read access to the data of the memory cells can be successively restricted by changing the value of at least one address boundary 225 in one direction.

Specifically, the address boundary 225 of the address boundary register 215 is set in the ascending 250 implementation of the address boundaries in the ascending order of their values, e.g. by register write access (via processing unit 505 or software module 510), and the set value is transmitted to the address logic module 515. The address logic module 515 may include the flip-flop device 31 shown in FIG. 3A and the request 10 (write_enable) for writing a new value of the address boundary. The address logic module 545 or the flip-flop component 31 are designed to check whether a new value of the address boundary (in FIG. 3A marked with b at the logic comparator element 45) is greater than a previous value (in FIG. 3A marked with a at the logic comparator element 45) of the at least one address boundary 225 and, if this is the case (together with the request 10 via the AND element 50), to adopt the set value. The at least one address boundary 225 is then validly set by register write access to the new address boundary (set address boundary 55 in FIG. 3A) with the larger value. In FIG. 3A, N denotes the bus width of the address bus.

Possible access addresses 240 in FIG. 2A are therefore those which correspond in value to the new value (b in FIG. 3A) of the address boundary 225 and/or are above the new value (b in FIG. 3A) of the address boundary 225. For such access addresses 240, write access and/or read access is carried out depending on the access type. The address boundary register 215 implemented as flip-flop component 31 can thus be shifted in the direction of arrow 233 with respect to the ascending 250 address boundaries. If the access address is outside the access range, where the access range in FIG. 2A is formed by the access addresses 240 (a blocked access address 245 is outside the access range according to FIG. 2A), access to the data of the memory cell 210 is not carried out and an error message (exception) is generated. It is therefore not possible to shift the address boundary 225 in the direction of the arrow 235 (i.e. to smaller values).

FIG. 4A shows the memory controller 500 with a processing unit 505 and the memory module 200 explained above with address boundary register 215 with ascending 250 address boundaries. The processing unit 505 (e.g. a processor) is operatively connected to the memory module 200 via a bus system 507. An address logic module 515 is also operatively connected between the processing unit 505 and the memory module 200 via the bus system 507 (the flip-flop component 31 from FIG. 3A is not shown here, which shows the implementation of the address boundary register 215 in hardware that is part of the address logic module 515). M, n stand for the individual bus widths, m for the width of the data bus and n for the width of the address bus, e.g. n=10 bit bus width and m=32 bit bus width. Different bus widths are also possible.

The memory module 200 can be designed as a non-volatile memory (NVM) and can have, for example, a flash memory architecture (for example, if security keys are stored that are intended to no longer be readable after a certain point in the start procedure). Alternatively, it is possible that the memory module 200 is designed as a volatile memory and has, for example, a RAM memory architecture (RAM: random access memory) (for example, if data are generated in the start procedure of the system which are to be protected for later read and/or write access).

The address logic module 515 is designed to provide the above-mentioned address boundary register 215 with the at least one changeable address boundary 225 for access.

The address logic module 515 comprises, in the illustration in FIG. 4A, a first logic comparator element 520 and a second logic comparator element 525. For example, the first logic comparator element 520 is linked to a write access 540 to the data of the memory cells 210 of the memory module 200 and the second logic comparator element 525 is linked to a read access 545 to the data of the memory cells 210 of the memory module 200. This has been chosen as an example in the illustration; it is understood that with exclusive write access 540 or exclusive read access 545 to the data of the memory cells 210 of the memory module 200 5, only one logic comparator element 520, 525 can be used in each case.

The change in the address boundary 225 takes place according to the explanation in FIG. 3A, where b in FIG. 4A of the logic comparator elements 520, 525 stands for the possible access address 240 and a stands for the current value of the address boundary 225. A first AND element 530 is connected to the first logic comparator element 520 and a schematic write-enable request 10 from the processing unit 505 to the memory module 200 via the bus system 507. This write access request 10 is complied with by the address logic module 515 (i.e., writing a data element in the memory cell 15 (write data) if the access address 240, when compared by the logic comparator element 520 with the address boundary 525 of the address boundary register, corresponds in value to the address boundary 225 of the address boundary register 215 or if the value of the access address 240 is above that of the variable address boundary 225 of the address boundary register 215.

This also applies analogously to the second logic comparator element 525 and the second AND element 535 for the read request 20 (read_enable) and the reading of a data element 25 (read_data) from the memory cells 210 of the memory module 200.

The software module 510 of the processing unit 505 is configured to set a new value of the address boundary 225 and to transmit the new value of the address boundary 225 to the address logic module 515, which provides the address boundary register 215. The address logic module 515 or the flip-flop component 31 are designed to check whether the set value of the address boundary is greater than a previous value of the at least one address boundary 225 and, if so, to transfer the set (greater) value to the address logic module 515. This applies without restriction to read access and write access.

In the ascending implementation 250, the address boundary register 215 can then no longer be reset to small values of the address boundaries. Consequently, access to these memory cells can be effectively prevented for less privileged parts of the firmware or software.

A possible application example may include storing a secret key for decrypting additional firmware components or software components at the lower end of the memory module 200, i.e. memory cells at the lower end of the memory module 200. After the firmware/software has completed the decryption, the address boundary 225 (as read address boundary), the value of which can be changed in the ascending direction, can be set above the key (e.g. hatched area in FIG. 2A as area for the key), as a result of which it is no longer possible to read this key until the next boot process or reset.

An alternative application example may include that calibration data for a MEMS component designed as a sensor, e.g. an inertial sensor, which includes the memory controller 500 explained above, can be stored in one or more memory cells of the memory module 200. For example, this data can only be written in a special calibration mode of the sensor firmware/software. If the firmware detects after the start process that the sensor firmware/software is in an operating mode, write access to this data can be blocked by setting the address boundary 225 for write access to a new value that is greater than the previous value of the address boundary 225 in order to protect the calibration data (e.g. hatched area in FIG. 2A as area for the calibration data).

It is understood that the application examples are also applicable with descending implementation 353 of the address boundaries and the data to be protected are then in each case stored in the upper area of the address boundary register 315.

In the following, FIGS. 2B, 3B and 4B are described together, with particular emphasis on the differences from the previous figures.

FIG. 2B shows a schematic representation of an implementation of an address boundary register 315 with descending address boundaries 353 of the method in FIG. 1, and FIG. 3B shows a schematic representation of the implementation of the address boundary register in FIG. 2B by means of flip-flop component 33. FIG. 4B shows a schematic representation of a memory controller 300 with the implementation of the address boundary register 315 with descending address boundaries 353 according to FIGS. 2B and 3B.

The address boundary 325 of the address boundary register 315 in the descending 353 implementation of the address boundaries is set in descending order of value if a new value (b in FIG. 3B) of the address boundary is smaller than a previous value (a in FIG. 3B) of the address boundary 325. This corresponds to the logic comparator element 45 in FIG. 3B. The at least one address boundary 325 is then set to the new (smaller) value 55. The flip-flop component 33 in FIG. 3B differs from the component 31 in FIG. 3A by the different arrangement of the reset input (in FIG. 3B the reset input is marked with S).

Possible access addresses 340 for accessing the data in the memory cells 210 in FIG. 2B are therefore those which correspond in value to the new address boundary 325 and/or are below the new address boundary 325 in value. For such access addresses 340, write access and/or read access is carried out depending on the type of access. The address boundary register 315 implemented as a flip-flop component 33 can thus be shifted in the direction of arrow 333 with respect to the descending 353 address boundaries.

The address logic of the address logic module 615 is designed similarly to the embodiment in FIG. 4A, but with the difference that the first logic comparator element 620 and the second logic comparator element 625 check possible access addresses 340 or new address boundaries, in each case according to the logic component 45 of FIG. 3B.

In the following, FIGS. 2C, 4C and 4D are described together, with emphasis on the differences from the previous figures.

FIG. 2C is a schematic representation of an implementation of two independent address boundary registers 415, 417 for the method 100 in FIG. 1, and FIG. 4C is a schematic representation of a memory controller 700 with the implementation of two independent address boundary registers 415, 417 in FIG. 2C with respect to write accesses 740 to the data of the memory cells 210 with the individual address boundary registers 415, 417. In the case of the first address boundary register 415, the independent address boundary registers 415, 417 can be realized so as to be ascending 450 in the address boundaries, i.e. in the direction of increasing values of the variable address boundary 425, and possible access addresses 440 can be mapped to larger values by changing the value of the address boundary 425 (shifting the arrow in the direction 433). Reference is made here to the explanation of FIGS. 2A, 3A, and 4A.

The second address boundary register 417 is realized in descending order 453 in the address boundaries, i.e. in the at least one changeable address boundary 455. Possible access addresses 475 can be mapped by changing the value of the address boundary 455 to smaller values (shifting the arrow in the direction 465). Reference is made here to the explanation of FIGS. 2B, 3B, and 4B.

It is understood that the above-mentioned type of access to the data of the memory cells 210 is not to be understood as restrictive for the two address boundary registers 415, 417, but can equally be realized in the form of read accesses or in the form of a write access 740 and a read access. Each of the address boundary registers 415, 417 may include an address logic module 715, 715, respectively, having the above-mentioned components.

FIG. 4D is a schematic representation of a memory controller 800 with the implementation of two independent address boundary registers 415, 417 according to FIGS. 2C and 3C.

In contrast to the figures mentioned, the memory controller 800 in FIG. 4D has only one address logic module 819. The address logic module 819 further comprises a switch element 823 (multiplexer) which is connected upstream of the logic comparator element 820 and the AND element 830. The processing unit 805 can have different rights (or modes), which is represented by a protect call 30 to the switch element 823. The different rights can be kernel (operating system) and user (software/firmware), or kernel mode and user mode. The switch element 823 is designed to switch from the first address boundary register 415 to the second address boundary register 417 and/or to switch from the second address boundary register 417 to the first address boundary register 415. The first address boundary register 415 and the second address boundary register 417 are formed independently of each other. In the example shown, the first address boundary register 415 forms the kernel register and the second address boundary register 417 forms the user register. The user mode calls the kernel mode, so that a change between the registers 415, 417 is necessary, wherein in the kernel register 415, for example, it would be checked whether access is permitted, i.e. possible, according to the procedure described above.

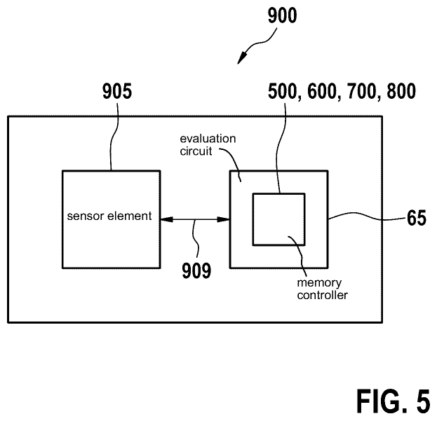

FIG. 5 is a schematic representation of a MEMS component 900. The MEMS component 900 comprises a MEMS element which is designed as a sensor element 905; in particular, the sensor element is designed as an inertial sensor element. The sensor element 905 is connected to an evaluation circuit 65 via an operative connection 909, wherein the evaluation circuit 65 can be designed as an ASIC and can comprise a microprocessor system (not shown) with a memory controller 500, 600, 700, 800. The memory controller 500, 600, 700, 800 can be designed as explained above. The memory controller 500, 600, 700, 800 is designed to execute the method 100 for operating the memory module 200, 300, 400.

The present invention can be used in connection with smartphones and tablets, wearables, hearables, AR and VR, drones, gaming and toys, robots, personal digital assistants, smart home, and in an industrial context for the following applications, among others:

Detection of significant movement, free fall detection, context detection, gesture control, altitude stabilization, floor detection, flight control, elderly care, calorie counter, navigation inside and outside buildings, position tracking, detection of boundaries and obstacles; detection of the wearing status of headphones/earphones (hearables) as in-ear detection,
determination of head orientation and head movement.

MEMS systems are used in various computer-controlled devices, such as robots, household appliances, production facilities, access control systems, vehicles (e.g. autonomous vehicles), and for active and passive safety, e.g. for ESP, rollover sensing, etc., and in driver assistance systems.

The present invention has been described in detail by means of preferred exemplary embodiments. Instead of the described exemplary embodiments, further exemplary embodiments are possible, which can have further modifications or combinations of described features. For this reason, the present invention is not limited by the disclosed examples since other variations can be derived therefrom by a person skilled in the art without departing from the scope of protection of the present invention.

What is claimed is:

1. A method for operating a memory module, comprising the following steps:
providing, in a first step, a memory module, wherein the memory module includes a memory area with a plurality of memory cells having data;
providing, in a second step, at least one address boundary register with at least one address boundary which can be changed in value at least in one direction, wherein the providing of the at least one address boundary register in the second step includes that the address boundary can be set to a new value and it can be checked whether the new value has been changed in a permissible direction; and
when there is an access, including a write access and/or read access, to the data of the memory cells of the memory module, checking whether the access is permissible, and, when the access is permissible, executing the access in a third step.

2. The method according to claim 1, wherein:
the at least one address boundary register is a digital flip-flop component, and
the check of whether the new value of the address boundary has been changed in the permissible direction is implemented based on a logic comparator element.

3. The method according to claim 1, wherein:
the address boundary register is implemented in ascending order address boundaries, and the address boundary is set to a smallest possible value of the memory module at system start,
the at least one address boundary in the ascending implementation of the address boundaries is set in an ascending direction of values when a new value of the address boundary is greater than a previous value of the address boundary,
and
the access is carried out in the third step when an access address has a value that corresponds at least to the value of the address boundary and/or is above the value of the address boundary.

4. The method according to claim 1, wherein:
the address boundary register is implemented in descending order in address boundaries and the address boundary is set to a largest possible value of the memory module at system start,
the at least one address boundary in the descending implementation is set in a descending direction of the values when a new value of the address boundary is smaller than a previous value of the address boundary, and
the access is carried out in the third step when an access address has a value that corresponds at least to the value of the address boundary and/or is below the value of the address boundary.

5. The method according to claim 1, wherein:
at least one first address boundary register and one second address boundary register are implemented, and are be formed independently of one another; and:
(i) the first address boundary register is implemented in ascending order of address boundaries and the second address boundary register is implemented in descending order of the address boundaries, and/or
(ii) the first address boundary register is implemented for write accesses and the second address boundary register is implemented for read accesses.

6. A memory controller, comprising:
a processing unit operatively connected via a bus system to a memory module which is configured as a non-volatile memory, wherein the memory module includes a memory area with a plurality of memory cells having data;
an address logic module operatively connected to the processing unit and the memory module via the bus system, wherein the address logic module is configured to provide at least one address boundary register with at least one address boundary;
wherein the processing unit includes a software module which is configured to change a value of the at least one address boundary in at least one direction;
wherein the address logic module is configured to set the address boundary to a new value and to check whether the new value has been changed in a permissible direction;
wherein the address logic module includes at least one further logic comparator element, wherein the at least one further logic comparator element is configured for an access, including write access and/or read access, to data of the memory cells, to check whether the access is permissible, and, when the access is permissible, to execute the access.

7. The memory controller according to claim 6, wherein:
the at least one address boundary register is a digital flip-flop component; and
the digital flip-flop component is configured to check whether the new value of the address boundary has been changed in the permissible direction based on the logic comparator element.

8. The memory controller according to claim 6, wherein:
the software module (of the processing unit is configured to set the at least one address boundary of the address boundary register in a direction of ascending value;
the software module of the processing unit is configured to transmit the set value to the address logic module;
the address logic module is configured to set the address boundary to a smallest possible value of the memory module when the system starts and to check whether a new value of the address boundary is greater than a previous value of the address boundary, and when this is the case, to adopt the set value of the address boundary;
the address logic module is configured to grant access to the processing unit when an access address corresponds in value to at least the value of the address boundary and/or is above the value of the address boundary.

9. The memory controller according to claim 6, wherein:
the software module of the processing unit is configured to set the at least one address boundary of the address boundary register in a direction of descending value;
the software module of the processing unit is configured to transmit the set value to the address logic module;
the address logic module is configured to set the address boundary to a largest possible value of the memory module when the system starts and to check whether a new set value of the address boundary is smaller than a previous value of the at least one address boundary, and, when this is the case, to adopt the set value of the address boundary;
the address logic module is configured to grant access to the processing unit when an access address corresponds in value to at least the value of the address boundary and/or is below the value of the address boundary.

10. The memory controller according to claim 6, wherein:
the address logic module includes a switch element;
the switch element is configured to switch from at least one first address boundary register to a second address boundary register and/or the switch element is configured to switch from at least one second address boundary register to a first address boundary register;
the first address boundary register and the second address boundary register are formed independently of one another.

11. A MEMS component, comprising:
a MEMS element including an inertial sensor element;
an evaluation circuit including a microprocessor system with a memory controller, the memory controller including:
a processing unit operatively connected via a bus system to a memory module which is configured as a non-volatile memory, wherein the memory module includes a memory area with a plurality of memory cells having data,
an address logic module operatively connected to the processing unit and the memory module via the bus system,
wherein the address logic module is configured to provide at least one address boundary register with at least one address boundary,
wherein the processing unit includes a software module which is configured to change a value of the at least one address boundary in at least one direction,
wherein the address logic module is configured to set the address boundary to a new value and to check whether the new value has been changed in a permissible direction,
wherein the address logic module includes at least one further logic comparator element, wherein the at least one further logic comparator element is configured for an access, including write access and/or read access, to data of the memory cells, to check whether the access is permissible, and, when the access is permissible, to execute the access.
